(19) United States
(12) Patent Application Publication
(10) Pub. No.: US 2015/0151903 A1
(43) Pub. Date: Jun. 4, 2015

(54) Capsule For Beverage And Method For Manufacturing Said Capsule

(71) Applicant: SARONG Societa' Per Azioni, Reggiolo (RE) (IT)

(72) Inventors: Andrea Bartoli, Reggio Emilia (IT); Davide Capitini, Reggio Emilia (IT)

(73) Assignee: SARONG SOCIETA' PER AZIONI, Reggiolo (RE) (IT)

(21) Appl. No.: 14/388,643

(22) PCT Filed: Mar. 26, 2013
(86) PCT No.: PCT/IB2013/052397

§ 371 Date: Sep. 26, 2014

(30) Foreign Application Priority Data
Mar. 26, 2012 (IT) MO2012A000080
Mar. 26, 2012 (IT) MO2012A000081

(51) Int. Cl. B65D 85/804; B29C 51/02; B29C 51/14

(52) U.S. Cl. CPC B65D 85/8043; B29C 51/14; B29C 51/02; B29K 2101/12

(57) ABSTRACT

A capsule for beverages includes a casing provided with a base wall and with a side wall defining a cavity that is suitable for containing an initial product to be combined with a fluid to obtain a final product in a dispensing machine into which the capsule is insertible; the casing includes a flange-shaped edge connected to the side wall and arranged for being clamped and compressed in a condition of use in the dispensing machine; the capsule includes a cover element that is fixed to the edge to seal hermetically the cavity and is made of yieldable and/or soft plastic material and such as to be deformed by and take on the shape of an abutting element of the dispensing machine when compressed, such as to sealingly engage the abutting element.

### FIELD OF THE INVENTION

The invention relates to capsules or containers for preparing products, for example beverages, in automatic dispensing machines. In particular, the invention relates to a sealed, single-dose and disposable capsule containing an initial product which is able to make a final product by interacting with pressurised fluid. The invention further relates to a method for making this capsule.

### BACKGROUND OF THE INVENTION

Known capsules for use in dispensing machines are disposable and single-dose containers comprising an external casing that is made of plastic material and which is impermeable to liquids and gases and is glass or cup-shaped. The casing has a bottom wall and a side wall defining an upper opening through which the product can be inserted from which to obtain the beverage. The upper opening is closed hermetically by a cover element, a film of aluminium or plastics, such as to seal the product inside the container. The cover element is generally fixed to a peripheral and annular flange-shaped edge of the casing, which is opposite the bottom wall and arranged around the upper opening.

The capsule is perforable to enable the pressurised liquid, typically water, to be delivered, and the obtained beverage to exit. In particular, the cover and the bottom wall of the casing are perforable by a suitable arrangement of a dispensing machine to enable respectively the pressurised liquid to be delivered from above and the beverage to be extracted from below.

As illustrated schematically in FIG. 1, a dispensing machine 500 of known type comprises a housing 501 arranged for receiving and enclosing a capsule 550. A bottom portion of the housing 501 is provided with a perforating arrangement 502 to pierce a bottom wall 551 of the capsule 550 and inject the pressurised fluid or extract the beverage therefrom. In order to prevent, during use, the fluid or beverage exiting from the housing 501 because of the high operating pressure, a sealing element 503 has to be interposed between the capsule 550 and the housing 501.

The sealing element 503 generally comprises an annular washer, made of elastomeric material, interposed between a flange edge 552 of the capsule 550 and an abutting portion 505 of the housing 501. When the capsule 550 is closed in the housing 501, the washer 503 is compressed by a perforating element 504, thus ensuring the hydraulic seal.

One drawback of such a solution lies in the fact that the washer, in addition to be subjected to wear and deterioration with use, comes into contact with the product and/or the fluid at each dispensing without being able to be appropriately washed subsequently. From a hygiene point of view this solution is then not optimum.

In order to overcome this drawback, capsules are known that comprise a sealing element made of yieldable, typically elastomeric, material that ensures the seal being crushed when the capsule is inserted into the dispensing machine. These capsules can also be used in dispensing machines that are devoid of the sealing element.

Patent EP 1654966 illustrates a capsule for beverages comprising an elastic sealing element made of elastomeric material that is different from the one used for forming the capsule. The elastic element can be fixed to the casing of the capsule at a peripheral edge or a bottom wall of said casing.

A capsule of this type is nevertheless very costly because a suitable sealing element has to be made and fixed to the casing of the capsule.

Documents US 2010/015307, EP 2151313, US 2011/079152, FR 2946854 and US 2010/203198 illustrate the preamble of the independent claims.

### SUMMARY OF THE INVENTION

One object of the present invention is to improve known capsules for beverages, in particular capsules that are usable in known dispensing machines provided with a housing that is suitable for containing and sealingly enclosing a capsule.

Another object is to make a capsule that is usable in known dispensing machines that ensures the seal during dispensing without the need for specific housing sealing element.

A further object is to obtain a cheap capsule that is simple to make.

In a first aspect of the invention a capsule is provided.

In a second aspect of the invention a method for making a capsule is provided.

In a third aspect of the invention, a capsule is provided.

In a fourth aspect of the invention, a method for making a capsule is provided.

### BRIEF DESCRIPTION OF THE DRAWINGS

The invention can be better understood and implemented with reference to the attached drawings that illustrate some embodiments thereof by way of non-limiting example, in which:

FIG. 1 is a schematic cross section of a known capsule for beverages associated with a dispensing machine that is also of known type;

FIG. 2 is a schematic cross section of a capsule according to the invention associated with a dispensing machine, which is partially illustrated;

FIG. 3 is a partial schematic cross section of the capsule in FIG. 2 associated with a different dispensing machine;

FIG. 4 is a partial schematic cross section of the capsule in FIG. 2 associated with another different dispensing machine;

FIG. 5 is a schematic cross section of a version of the capsule in FIG. 2;

FIG. 6 is a schematic section of another version of the capsule in FIG. 2;

FIG. 7 is a schematic section of still another version of the capsule;

FIG. 8 is a schematic section of a further version of the capsule.

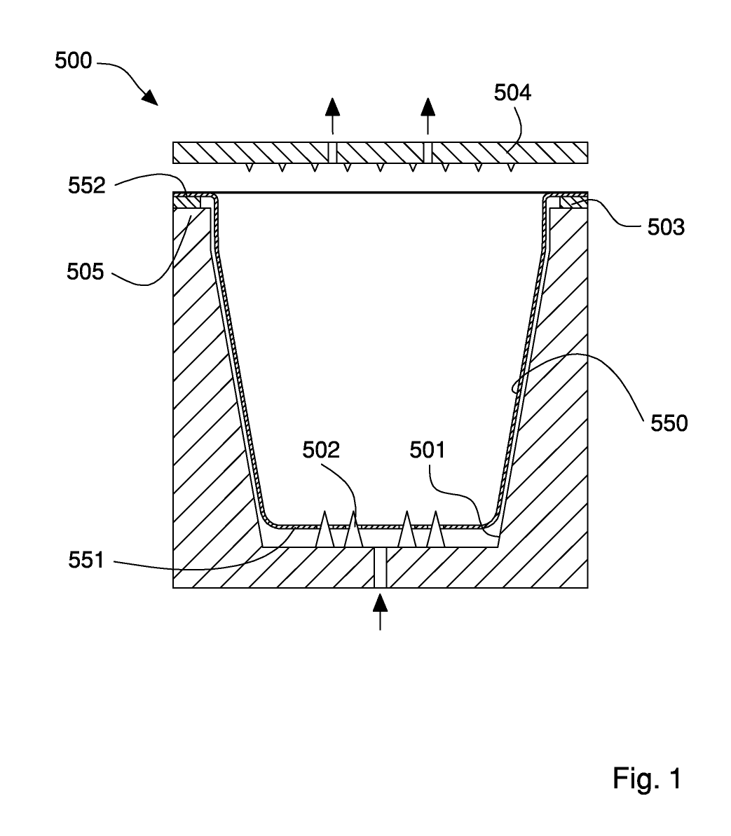

### DETAILED DESCRIPTION OF THE INVENTION

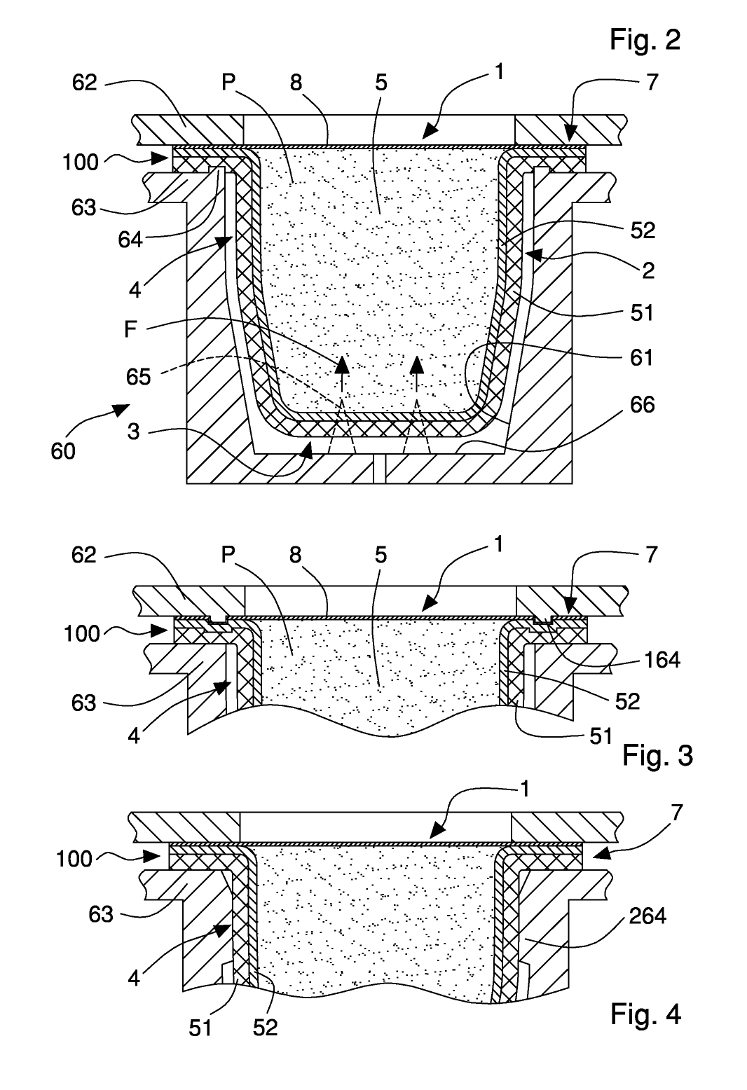

With reference to FIG. 2, a capsule 1 for beverages according to the invention is illustrated, which is usable in a dispensing machine 60, disclosed below, for producing a final product, in particular a hot beverage, for example coffee, barley, herbal tea, tea, chocolate, etc., by injecting a hot pressurised fluid F therein.

The capsule 1 comprises an external casing or container 2, which is substantially glass or cup-shaped, provided with a base wall 3 and with a first side wall 4 defining an open cavity 5 and which is suitable for containing an initial product P, for example a soluble or percolable food product to be combined with a fluid, typically water, to obtain a final product.

The casing comprises a flange-shaped edge 7 connected to the side wall 4 and arranged around the opening of the cavity 5. The edge 7 is further opposite the base wall 3 and turned outwards with respect to the cavity 5.

The casing 2 is made by forming a sheet of thermoformable plastic material 100 which comprises at least a first layer 51 of soft and/or deformable and/or yieldable material arranged for being deformed, accommodated on and sealingly engaged with an abutting element 64 of the dispensing machine 60, when the layer is compressed. In particular, the first layer 51 when compressed against the abutting element 64 substantially assumes the shape of the abutting element 64 so as to ensure a seal that prevents pressurised fluid or final product from exiting.

The sheet 100 further comprises a second layer 52 of appropriate material that is suitable to contact the initial product P. More precisely, the second layer 52 is inside and in contact with the initial product P, whereas the first layer 51 is outside and not in contact with the product.

The material of the second layer 51, in addition to being suitable for contact with the initial product, for example food or cosmetic or pharmaceutical product, is suitable for the process of preparing the final product, the material being for example able to withstand temperatures up to 100° C. and pressure up to 5 bar without being deformed.

The material of the first layer 52 is yieldable, i.e. soft and/or deformable in such a manner as to take on the shape of the abutting element 64 to ensure by virtue of the contact pressure the seal between the capsule 1 and the abutting element 64, as illustrated better below in the description.

The first layer 51 and the second layer 52 of the sheet are, in particular, co-extruded layers, i.e. layers coupled during the process of extrusion to form the multilayered sheet 100.

Alternatively, the two layers 51, 52 can be extruded separately and coupled subsequently.

In a first embodiment the first layer 51 is made of expanded plastic material, in particular one among expanded polyethylene (PET), expanded polypropylene (PP), expanded polystyrene (PS), expanded polyvinyl chloride (PVC), expanded polyamide (PA). Said expanded plastic material has, in particular, a substantially spongy cellular structure with open cell.

In a second embodiment the first layer 51 is made of foamed plastic material.

In a third embodiment the second layer 51 is made of elastomeric material, for example a film of silicone or rubber.

The first layer 51 has a thickness comprised between 200 and 1000 μm, in particular between 300 and 800 μm. The second layer 52 has a thickness comprised between 50 and 800 μm, in particular between 50 and 300 μm.

The capsule further comprises a cover element 8 that is fixed to the edge 7 of the casing 2 for hermetically closing the capsule 1, i.e. the cavity 5 and thus preserve the product P. The cover element 8 comprises a film of aluminium or plastic that is perforable by an arrangement for injecting the fluid or an arrangement for extracting the final product of the dispensing machine 60.

The cover element 8 is fixed to the edge 7 of the casing 2 by thermal or ultrasound welding, or by gluing.

As illustrated in FIG. 2, the dispensing machine 60, which is of known type and is not disclosed in detail, comprises a seat or space 61 that is suitable for receiving and containing the capsule 1 and a locking element 62 arranged for locking firmly the capsule 1 inside the aforesaid space 61 in an operating configuration.

In one condition of use, the flange edge 7 of the capsule 1 is clamped and compressed in the dispensing machine 80, in particular between the locking element 62 and a supporting portion 63 of the space 61.

The locking element 62 comprises, for example, an annular plate that acts on the edge 7 of the casing 2.

An abutting element 64 is provided on the supporting portion 63 of the space 61 and comprises one or more annular ridges that abut on the first layer 51 at the edge 7. As the first layer is made of yieldable, i.e. soft and/or deformable plastic material, owing to the contact pressure generated by the locking element 62 in the operating or use configuration, this first layer is deformed locally and substantially takes on the shape of the abutting element 64, in particular of the annular ridges. This deformation, together with the contact pressure, ensures an optimum seal of the edge 7 with the supporting portion 63 of the space 61, this seal preventing pressurised fluid or final product from exiting from the aforesaid space 61 during a dispensing operating step.

The capsule 1 thus ensures an optimum seal inside the dispensing machine, during the dispensing step without requiring the use of specific washers associated with the dispensing machine and/or with the capsule.

In this manner, optimum hygiene conditions are ensured in the dispensing procedure and modest capsule production costs, as the capsule can be obtained easily and rapidly by thermoforming of a sheet of multilayered plastic material. Further, the capsule can be adapted to the different embodiments of the abutting element and/or of the abutting portions of the dispensing machines, without the need to make different edges 7 shaped for different abutting element and/or abutting portions. This enables production costs to be reduced considerably.

In the embodiment illustrated in FIG. 2, the dispensing machine 60 comprises an injection arrangement 65 for injecting the fluid that is located on the bottom 66 of the space 61 and is arranged for piercing the base wall 3 of the capsule and injecting the pressurised fluid into the cavity 5.

An extraction arrangement is provided for piercing the cover element 8 so as to enable the final product to exit the capsule 1.

Alternatively, the dispensing machine can comprise an injection arrangement arranged for piercing the cover element 8 and delivering into the cavity 5 the fluid to be combined with the initial product P and an extraction arrangement located on the bottom 66 of the space 61 for piercing the base wall 3 and enabling the final product to exit.

FIG. 3 illustrates a version of the dispensing machine 60 in which the abutting element 164 is made on the locking element 62. In this case, in one condition of use with the edge 7 clamped and compressed between the locking element 62 and the supporting portion 63 of the space 1, beyond the first layer 51, the second layer 52 is also deformed locally, which is directly in contact with and abuts on the annular ridges of the abutting element 164. The seal of the edge 7 with the supporting portion 63 of the space 61, which prevents the pressurised fluid or final product from exiting the space 61, is always ensured by the local deformation and contact pressure that are achieved by the first layer 51, which this time is in contact with the supporting portion 63.

FIG. 4 illustrates another version of the dispensing machine in which the abutting element 264 comprises an annular ridge that is made inside the space 61 and is intended to abut on and compress the first layer 51 at a portion, for example an upper portion, of the side wall 4 of the casing 2.

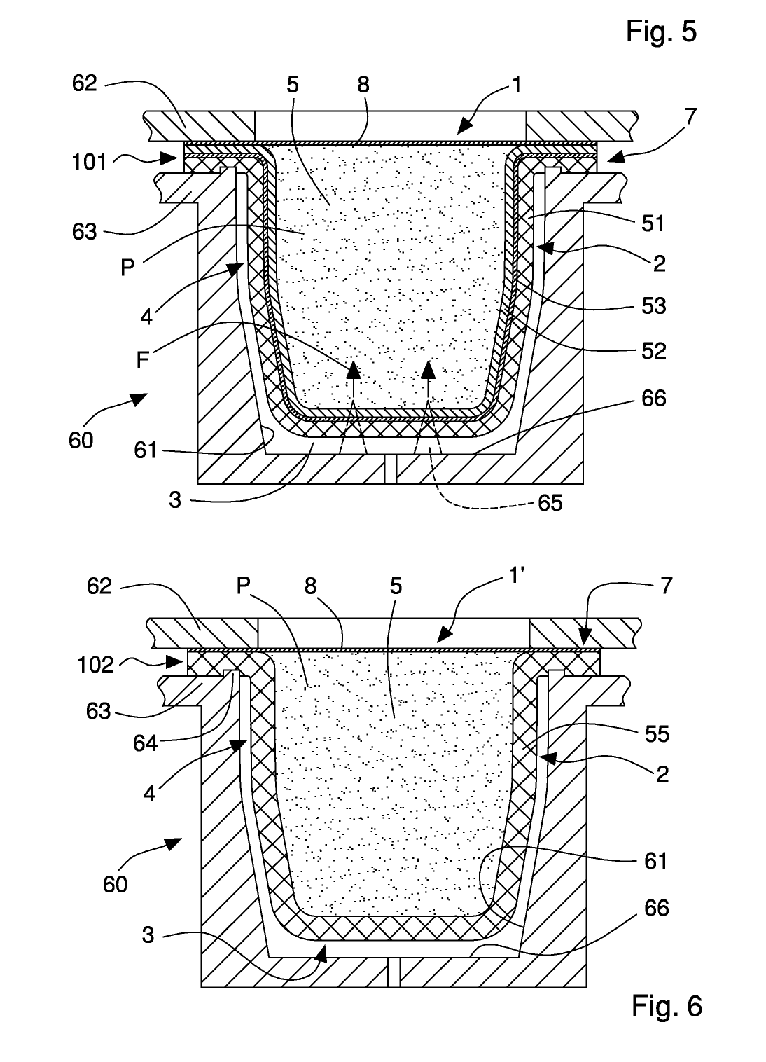

With reference to FIG. 5, a version of the capsule 1 is illustrated in which the sheet 101 of plastic material with which the casing 2 is made by thermoforming, also comprises a third layer 53 interposed between the first layer 51 and the second layer 52, said third layer 53 being made of a material that is impermeable, in particular to oxygen and to humidity. The aforesaid third layer 53, which is commonly known as a barrier layer, and used for ensuring complete insulation of the external environment of the cavity 5, in particular if the first layer 51 and the second layer 52 are permeable over time to oxygen and humidity.

The third layer 53 has a thickness comprised between 10 and 100 mm, in particular between 60 and 80 mm, and is for example made of one among ethylene vinyl alcohol (EVOH), polyvinylidene chloride (PVDC), polyamide (PA).

The method for making the capsule 1 disclosed above provides in a first step for making the sheet 100 of plastic material by coextruding or separately extruding and subsequent coupling of a first layer 51 made of yieldable and/or soft material, in particular of expanded plastic material or of elastomeric material, and a second layer 52 of appropriate material that is suitable for contacting and preserving the initial product P.

Subsequently, in a second step, the sheet 100 is thermoformed in such a manner as to form at least one casing 2 provided with a base wall 3 and with a side wall 4 defining a cavity 5 that is suitable for containing the initial product P.

Once the cavity 5 has been filled with a dose of initial product P, the casing 2 can be hermetically closed, isolating the cavity 5 with the initial product P from the external environment, fixing a cover element 8 to an edge 7 of the casing 2.

With reference to FIG. 6, a version of the capsule 1′ is illustrated that differs from the embodiments disclosed above by the fact that the casing 2 is made by forming a sheet of thermoformable plastic material 102 comprising only the first layer 55 made of yieldable and/or soft material arranged for being deformed, accommodated on and sealingly engaged with an abutting element 64 of the dispensing machine 60, when it is compressed.

The material of the first layer 55 is further suitable for contact with the initial product P and for the process of preparing the final product, which is for example able to withstand temperatures up to 100° C. and pressure up to 5 bar.

The method for making this capsule 1′ provides for thermoforming the sheet 102 so as to form the casing 2 provided with a base wall 3 and with a side wall 4 defining a cavity 5 that is suitable for containing the initial product P.

Once the cavity 5 has been filled with a dose of initial product P, the casing 2 can be hermetically closed, by insulating the cavity 5 with the initial product P from the external environment, fixing a cover element 8 to an edge 7 of the casing 2.

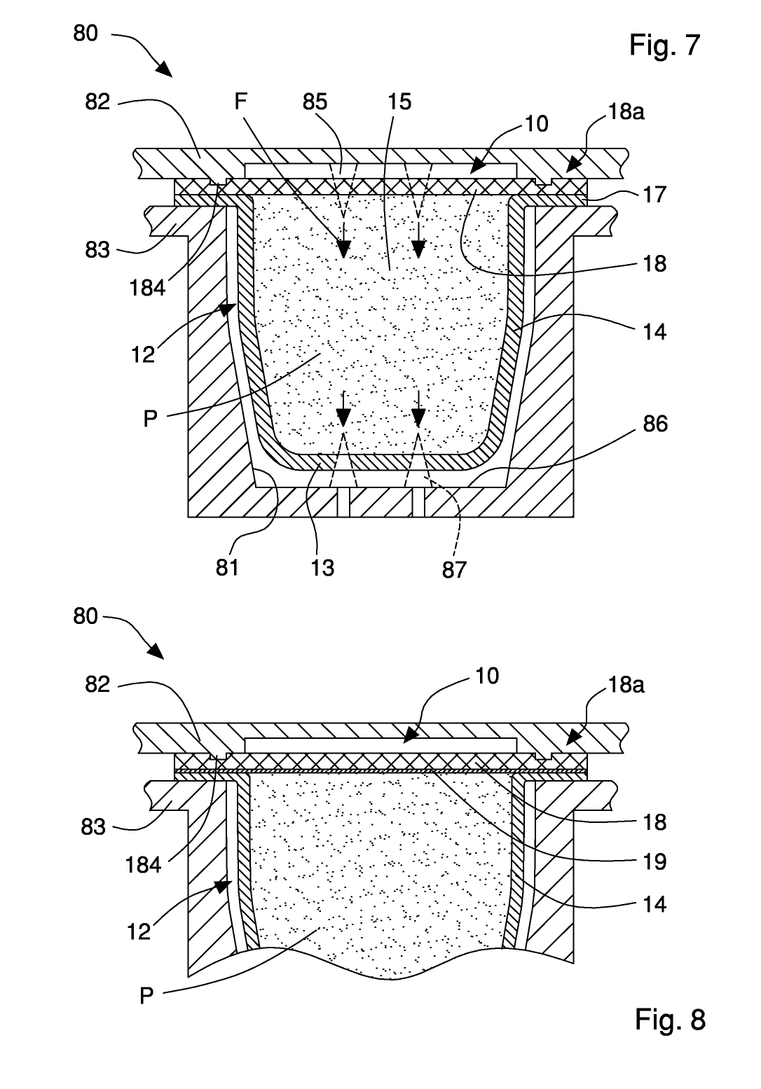

With reference to FIG. 7 the capsule for beverages according to the invention is illustrated that is usable in a dispensing machine 80 that is similar to the dispensing machine disclosed above.

The capsule 10 comprises a casing 12 that is substantially glass or cup-shaped, provided with a base wall 13 and with a side wall 14 defining a cavity 15 that is open and suitable for containing the initial product P to be combined with a fluid, typically water, to obtain a final product.

The casing 12 comprises a flange-shaped edge 17 connected to the side wall 4 and arranged inside the opening of the cavity 15. The edge 17 is opposite the base wall 13 and turns outwards with respect to the cavity 15.

The casing 12 is made by forming a sheet of thermoformable plastic material that is suitable for contact with the initial product P, for example food or cosmetic or pharmaceutical product, and for the process of preparing the final product, which is for example able to withstand temperatures up to 100° C. and pressure up to 5 bar without deformation.

The capsule 10 also comprises a cover element 18 that is fixed to the edge 17 of the casing 12 such as to seal hermetically the cavity 15 and preserve the initial product P contained therein. The cover element 18 is made of soft and/or deformable and/or yieldable plastic material arranged for deforming and sealingly engaging, when compressed, with the abutting element 184 of the dispensing machine 80 in a use condition, as explained better further on in the description.

The cover element 18 is fixed to the edge 17 by thermal or ultrasound welding or by gluing.

The plastic material of the cover element 18 is yieldable, i.e. soft and/or deformable in such a manner as to take on the shape of the abutting element 184 when compressed and ensure by virtue of the contact pressure the seal between the capsule 10 and the abutting element 184.

In a first embodiment the cover element 18 is made of expanded plastic material, in particular one among expanded polyethylene (PET), expanded polypropylene (PP), expanded polystyrene (PS), expanded polyvinyl chloride (PVC), expanded polyamide (PA). Said expanded plastic material has, in particular, a substantially spongy cellular structure with open cell.

In a second embodiment the cover element 18 is made of foamed plastic material.

In a third embodiment the cover element 18 is made of elastomeric thermoplastic material.

The cover element 18 has a thickness comprised between 200 and 1000 μm, in particular between 300 and 800 μm.

The material of the cover element 18 is further suitable for contact with the initial product P, for example a food or cosmetic or pharmaceutical product, and for the process of preparing the final product, which is for example able to withstand temperatures up to 100° C. and pressure up to 5 bar without deformation.

The cover element 8 is further perforable by an injection arrangement for injecting the fluid or by an extraction arrangement for extracting the final product of the dispensing machine 80.

As illustrated in FIG. 7, the dispensing machine 80 comprises a space 81 that is suitable for receiving and containing the capsule 1 and a locking element 82 arranged for firmly locking the capsule 10 inside the aforesaid space 81 in a use condition.

In such a use condition, the flanged edge 17 of the capsule 10 and the cover element 18 are clamped and compressed in the dispensing machine 80, in particular between the locking element 82 and a supporting portion 83 of the space 81.

The locking element 82 comprises, for example, an annular plate that acts on the edge 17 of the casing 12 and on an annular peripheral portion 18a of the cover element 18.

An abutting element 184 is made on the locking element 82 and comprises one or more annular ridges that abut on the annular peripheral portion 18a of the cover element 18. As the latter is made of yieldable, i.e. soft and/or deformable plastic material, because of the contact pressure generated by the locking element 82 (in cooperation with the supporting portion 83 of the space 81), the cover element 18 deforms locally and substantially takes on the shape of the abutting element 184, in particular of the annular ridges of the latter. This deformation, together with the contact pressure, ensures an optimum seal of the edge 17 with the supporting portion 83 of the space 81 and with the locking element 82, said seal preventing pressurised fluid or final product from exiting during a dispensing operating step.

The capsule 10 of the invention thus ensures an optimum seal inside the dispensing machine, during the dispensing step without requiring the use of specific washers associated with the dispensing machine and/or with the capsule.

In the embodiment illustrated in FIG. 7, the dispensing machine 80 comprises an injection arrangement 85 arranged for piercing the cover element 18 and delivering into the cavity 15 the fluid F to be combined with the initial product P and an extraction arrangement 87 located on the bottom 86 of the space 61 to pierce the base wall 3 and enable the final product to exit.

Alternatively, the dispensing machine 60 can comprise an injection arrangement for injecting the fluid, the injection arrangement being located on the bottom 86 of the space 81 and being arranged for piercing the base wall 13 of the capsule 10 and injecting the pressurised fluid into the cavity 5. An extraction arrangement is provided for piercing the cover element 18 so as to enable the final product to exit the capsule 1.

The method for making the capsule 10 disclosed above provides in a first step for forming a sheet of thermoformable plastics so as to make a casing 12 provided with a base wall 13 and with a side wall 14 defining a cavity 15.

Subsequently, in a second step, the cavity 15 is filled with a dose of initial product P.

In a third step, a cover element 18 is fixed to an edge 17 of the casing 12 such as to seal hermetically the cavity 15, the cover element 18 being made of deformable and/or yieldable and/or soft plastic material arranged for being deformed to sealingly engage, when compressed, with the abutting element 184 of the dispensing machine 80.

FIG. 8 illustrates another version of the capsule 10 that differs from the embodiment shown in FIG. 7 by the fact that it comprises a further cover element 19 associated with the cover element 18 and interposed between the latter and the edge 17 in such a manner as to face the cavity 15. The further cover element 19 is made of a material that is impermeable, in particular to oxygen and to humidity.

The aforesaid further cover element 19, which is commonly known as a barrier layer, is used to ensure complete insulation of the cavity 15 from the external environment, in particular if the cover element 18 is made of plastic material that is permeable over time to oxygen and to humidity.

The further barrier element 19 has a thickness comprised between 10 and 100 mm, in particular between 60 and 80 mm, and is made, for example, of one among ethylene vinyl alcohol (EVOH), polyvinylidene chloride (PVDC), polyamide (PA).

1-25. (canceled)

26. A capsule for beverages comprising a casing provided with a base wall and with a side wall defining a cavity that is suitable for containing an initial product to be combined with a fluid to obtain a final product in a dispensing machine into which said capsule is insertible, said casing comprising a flange-shaped edge connected to said side wall and arranged for being clamped and compressed in a condition of use in said dispensing machine, said capsule comprising a cover element fixed to said edge to seal hermetically said cavity, wherein said cover element is made of yieldable material such as to be deformed by and take on the shape of an abutting element of said dispensing machine when compressed, in such a manner as to sealingly engage said abutting element.

27. The capsule according to claim 26, wherein said cover element is made of expanded plastic material, in particular one among expanded polyethylene, expanded polypropylene, expanded polystyrene, expanded polyvinyl chloride, expanded polyamide.

28. The capsule according to claim 26, wherein said cover element is made of foamed plastic material.

29. The capsule according to claim 26, wherein said cover element is made of elastomeric plastic material.

30. The capsule according to claim 26, wherein said cover element has a thickness comprised between 200 and 1000 μm, in particular between 300 and 800 μm.

31. The capsule according to claim 26, wherein said yieldable material of said cover element is a material that is suitable for contacting and/or containing said initial product.

32. The capsule according to claim 26, wherein said cover element is perforable by an injection arrangement or extraction arrangement of said dispensing machine.

33. The capsule according to claim 26, comprising a further cover element associated with said cover element and interposed between the latter and said edge in such a manner as to face said cavity, said further cover element being made of a material that is impermeable, in particular to oxygen and to humidity.

34. The capsule according to claim 26, wherein said casing is made by forming a sheet of thermoformable plastic material.

35. A method for making a capsule for beverages containing an initial product, comprising the steps of:
forming a sheet of thermoformable plastic material so as to make a casing provided with a base wall and with a side wall defining a cavity;
filling said cavity with said initial product;
fixing a cover element to an edge of said casing such as to seal hermetically said cavity, said cover element being made of yieldable material arranged for being deformed and accommodated on, when compressed, an abutting element of a dispensing machine into which said capsule is insertible.

36. A capsule for beverages comprising a casing provided with a base wall and with a side wall defining a cavity that is suitable for containing an initial product to be combined with a fluid to obtain a final product in a dispensing machine into which said capsule is insertible, said casing comprising a flange-shaped edge connected to the side wall and arranged for being clamped and compressed in a condition of use in said dispensing machine, wherein said casing is made with a sheet of thermoformable plastic material which comprises at least a first layer made of yieldable material and such as to be deformed by and take on the shape of an abutting element of said dispensing machine when compressed, in such a manner as to sealingly engage said abutting element.

37. The capsule according to claim 36, wherein said sheet of thermoformable plastic material comprises a second layer of material that is in particular suitable for contacting and/or preserving said initial product.

38. The capsule according to claim 36, wherein said first layer is made of expanded plastic material, in particular one among expanded polyethylene, expanded polypropylene, expanded polystyrene, expanded polyvinyl chloride, expanded polyamide.

39. The capsule according to claim 36, wherein said first layer is made of foamed plastic material.

40. The capsule according to claim 36, wherein said first layer is made of elastomeric material, in particular rubber or silicone.

41. The capsule according to claim 36, wherein said first layer made of yieldable material is a material suitable for contacting and/or preserving said initial product.

42. The capsule according to claim 36, wherein said first layer has a thickness comprised between 200 and 1000 μm, in particular comprised between 300 and 800 μm.

43. The capsule according to claim 37, wherein said first layer and said second layer are co-extruded to form said sheet of thermoformable plastic material.

44. The capsule according to claim 37, wherein said first layer and said second layer are separately extruded and subsequently coupled to form said sheet of thermoformable plastic material.

45. The capsule according to claim 37, wherein said second layer has a thickness comprised between 50 and 800 μm, in particular between 50 and 300 μm.

46. The capsule according to claim 37, wherein said sheet of thermoformable material comprises a third layer interposed between said first layer and said second layer, said third layer being made of a material that is impermeable, in particular to oxygen and to humidity.

47. The capsule according to claim 36, comprising a cover element fixed to an edge of said casing to seal hermetically said cavity, said cover element being perforable by an injection arrangement or extraction arrangement of said dispensing machine.

48. A method for making a capsule for beverages comprising thermoforming a sheet of thermoformable plastic material which comprises at least a first layer of yieldable material, so as to form a casing of said capsule provided with a base wall and with a side wall defining a cavity that is suitable for containing an initial product.

49. The method according to claim 48, comprising, before said thermoforming, making said sheet of thermoformable plastic material by coextruding said first layer and a second layer of plastic material which is suitable for contacting and/or preserving said initial product.

50. The method according to claim 48, comprising, before said thermoforming, making said sheet of thermoformable plastic material by separately extruding and subsequently coupling said first layer and a second layer of appropriate plastic material that is suitable for contacting and/or preserving said initial product.
